(19) United States
(12) Patent Application Publication
(10) Pub. No.: US 2009/0302101 A1
(43) Pub. Date: Dec. 10, 2009

(54) Process for product traceability without addition or modification of the material using a digital signature obtained from one or more intrinsic product characteristics

(76) Inventors: Guillaume Poizat, Le Mesnil Le Roi (FR); Bruno Chabannes, Neuilly Sur Seine (FR); Frédéric Verrue, Neuilly Sur Seine (FR)

Correspondence Address: NIXON & VANDERHYE, PC, 901 NORTH GLEBE ROAD, 11TH FLOOR, ARLINGTON, VA, 22203, US

(21) Appl. No.: 12/308,259

(22) PCT Filed: Jun. 13, 2007
(86) PCT No.: PCT/FR2007/051432

§ 371 Date: Mar. 6, 2009

(30) Foreign Application Priority Data
Jun. 14, 2006 (FR) 0605269

(51) Int. Cl. G06K 9/52; G06F 17/00; G06K 19/00; G06K 7/10; G06K 7/00

(52) U.S. Cl. 235/375; 235/487; 235/454; 235/439

(57) ABSTRACT

A method for the tracing of products with no addition or change to the material, using a digital signature obtained from one or more macroscopic intrinsic characteristics of the product.

This present invention concerns the technical field of product tracing and the protection of brands.

There exist many technologies that have been developed to protect and to trace products.

In essence, these consist of incorporating a mark into the products, this mark being either visible or hidden.

These solutions are in response to problems regarding logistics, management of flows and stocks, or in order to combat selling in parallel markets, and to counter the sale and distribution of counterfeit goods.

The simplest solutions consist of printing a number, a barcode, or matrix data on the various packs employed (primary, secondary, etc.). The most sophisticated involve the incorporation of RFID microchips, laser engraving on the inner walls of glass (in the case of glass containers for example), and including the incorporation of artificial DNA, nanotechnologies, and so on.

However, a major drawback of current tracing or authentication solutions is that they can be destroyed or damaged by the parallel networks and counterfeiters. These networks are capable of investing heavily in order to counter the current tracing solutions. All of these have been destroyed or rendered unreadable within a short time

Application FR 2,870,376 proposes a method for the authentication of fibrous media, of the paper type for example, based on comparison of a digital signature of the tested fibrous product with a digital signature generated from an authentic fibrous medium. In this method, use is made of a digital signature that is common to all of the authentic products and not to a unique digital signature of the object tested. Moreover, the signatures actually described in this document are signatures that were obtained from microscopic characteristics of the product.

U.S. Pat. No. 5,673,338 and the articles of Wilkes et al. (Materials World, Institute of Metals, London, 12, 1994) and Buchanan et al. (Nature 436, 2005, p 475) also concern a method for the identification of an object based on the use of a digital signature obtained from microscopic characteristics of this object. These methods thus involve the acquisition of a microscopic image of part of the object, at a given level of magnification, requiring a microscopy instrument and focussing operations.

There therefore exists a need for methods and techniques for the tracing of manufactured products, which are reliable, easy to use, not dependent on added marks, and difficult to destroy without damaging the products themselves. This present invention allows this need to be met.

This present application in fact concerns a new method for the tracing of manufactured products, in particular such as flasks or packs, which is based in part on the determination of a digital signature proper to each product, from one or more macroscopic characteristics of the latter.

This present invention is to the manufactured product what the fingerprint is to the human.

This present invention uses one or more macroscopic characteristics proper to each product in order to identify it in a unique manner and to trace it. This allows a manufactured product to be identified in a reliable manner.

The purpose of this present invention is to describe the use of a digital signature that is obtained from at least one intrinsic macroscopic physical or geometrical characteristic of a manufactured product, without the addition of a mark, the addition of material, and without changing the material.

Certain manufactured or artisanal products, in whole or in part, come in complex shapes that are random, chaotic, unique and stable, not suitable for copying reproduction, and difficult to tamper with.

The characteristics of the manufactured products, in whole or in part, can be the thickness of the walls for example, the internal or external shapes, the resistivity, or any other macroscopic physical characteristics at the scale of the product that are particularly different.

For example, there exist different ways of manufacturing flasks or primary packs for cosmetic products, though none of these methods is capable of producing flasks or primary packs that are rigorously identical.

By virtue of their methods of manufacture, the flasks or primary packs are all different. These differences are sometimes detectable to the naked eye.

These flasks are used very widely in the perfume industry and are essentially in glass, or of glass and metal or plastic composition.

Moreover, the material elements chosen will be relatively invariant over time.

Thus, several readings of the digital signature of a given individual manufactured product will produce an identical digital signature.

This present invention is completely compatible with drinks or cosmetic products, since no addition is necessary and the means of acquisition are not destructive to the drinks or cosmetic products.

This present invention fully respects the aesthetic appearance of the products, since no addition is necessary.

This present invention is able to generate a virtually infinite number of unique signatures.

This present invention fits easily into production and logistics chains without interfering with them. This present invention is used to install a remote acquisition system that can be installed without any modification of the packaging chain.

One object of the invention therefore concerns a method for the tracing of a product, characterised by the use of at least one digital signature proper to the product, obtained from at least one intrinsic geometrical and/or physical macroscopic characteristic of said product, in whole or in part, without the addition of a mark or of material.

In one particular embodiment, the tracing method includes a stage for the reading of a digital signature proper to the product, obtained beforehand from at least one intrinsic geometrical and/or physical macroscopic characteristic of said product, in whole or in part, that renders account of its random, unique and stable structure.

According to a preferred and advantageous variant of the method of the invention, trace reading cannot be prevented. Thus, the method advantageously includes a stage for the acquisition of a digital signature from at least one intrinsic geometrical and/or physical macroscopic characteristic of said product, in whole or in part, in which the alteration necessary to prevent reading results in damage to the appearance of the product that is sufficient to prevent its sale, or even its destruction.

The invention is applicable to any type of manufactured product, in particular a flask (for perfume for example), a bottle, a box, a tube, a pack (a primary cosmetics pack for example), and so on. It is particularly designed for manufactured products in the field of cosmetics.

The digital signature can be obtained in different ways, and in particular by optical, sound, laser and/or X-ray means.

One particular subject of the invention concerns a method that includes the following stages:

a) determination of a zone for the acquisition of a digital signature on the product;

b) acquisition of a geometrical and/or physical characteristic of the product, at the level of said acquisition zone;

c) acquisition of a digital signature from the characteristic obtained in b);

d) storage of the digital signature, with a view to its later reading in the context of a tracing procedure.

Another subject of the invention concerns the use of a digital signature proper to a manufactured product, obtained from at least one intrinsic geometrical and/or physical macroscopic characteristic of said manufactured product, to identify said product in a unique manner and to enable it to be traced. Advantageously, the digital signature is obtained without the addition of material or other modification.

In a particular embodiment, the macroscopic characteristic is chosen from amongst the thickness of the walls of the product, its external or internal shapes, and its resistivity.

Another object of the invention concerns an installation for the production of a manufactured product, characterised in that it includes a system for the acquisition of a digital signature from at least one macroscopic characteristic of each manufactured product, allowing its identification in a unique manner.

Another subject of this present invention concerns a method for the production of a manufactured product, characterised in that it includes a stage for the acquisition of a digital signature from at least one macroscopic characteristic of the manufactured product, which allows its identification in a unique manner.

Another subject of the invention concerns a method for identifying the origin of a manufactured product, characterised in that it includes a stage for the determination of at least one digital signature proper to the product, from at least one intrinsic geometrical and/or physical macroscopic characteristic of said product, in whole or in part, and comparison of this signature with a pre-recorded signature, which is then used to attest to the origin of the product.

Other aspects and advantages of the invention will appear on reading the description that follows of embodiments of the invention, with reference to the appended drawings, in which:

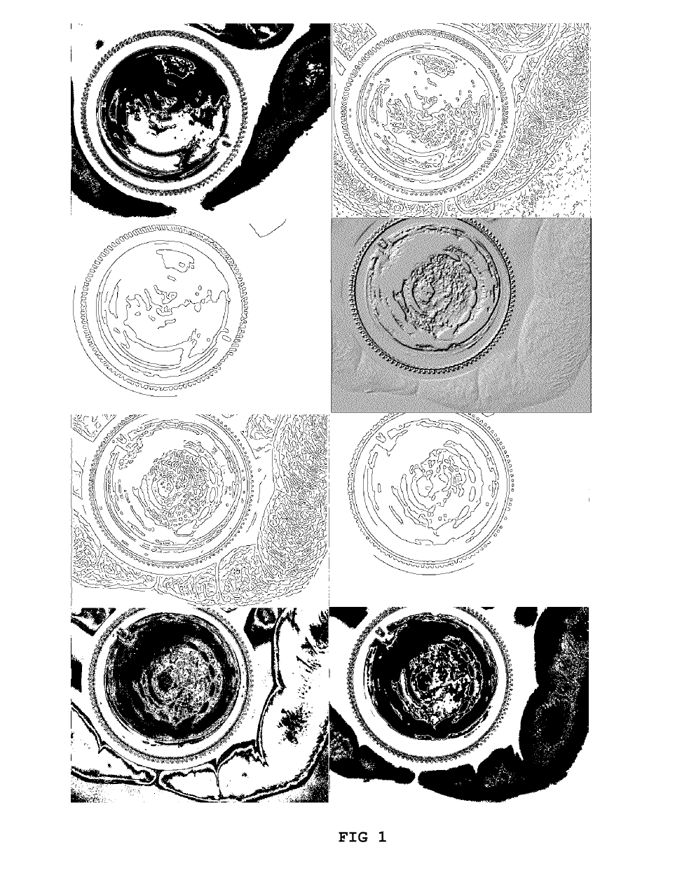

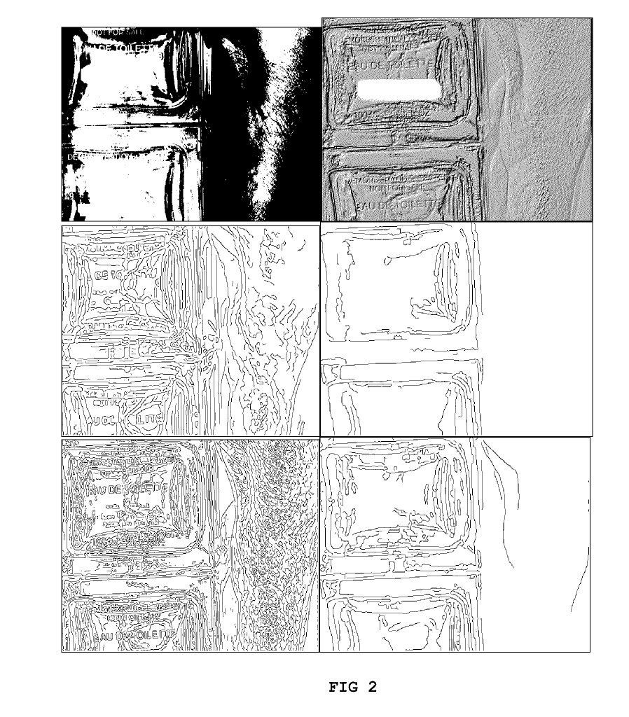

FIG. 1, FIG. 2 and FIG. 4 represent images of manufactured products taken from the perfume industry, taken directly and treated with different filters.

FIG. 4 shows an example of the difference of the angle between the synchronised internal contours of two different flasks;

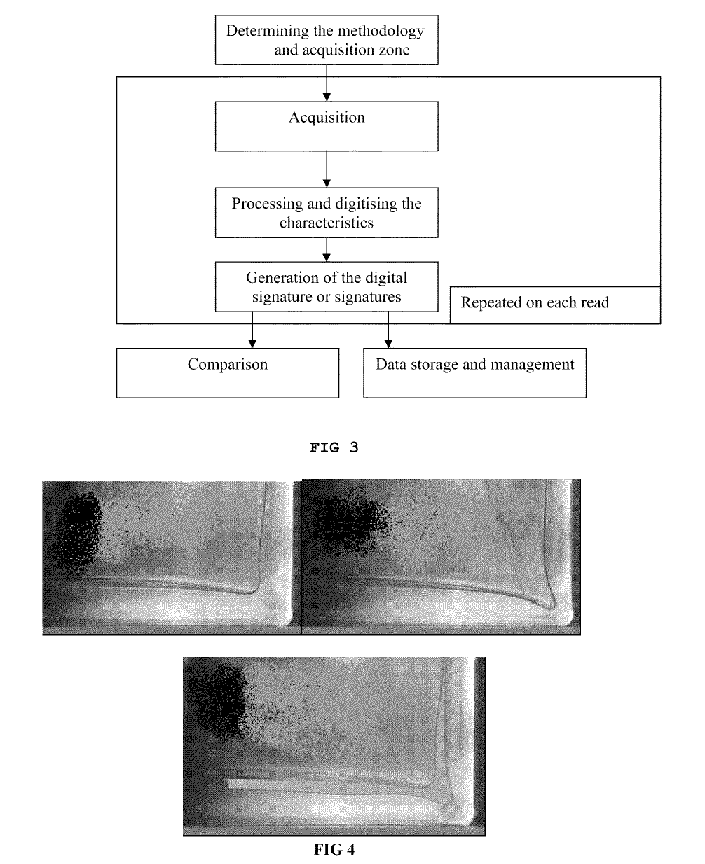

FIG. 3 shows the stages of a method according to this present invention.

The method described in FIG. 3 breaks down conventionally into the following stages:

1. For each type of manufactured product, and for each chosen characteristic, a methodology and an acquisition zone are determined.

The selection criteria are multiple, and include the characteristics chosen, the facilities for acquisition and analysis, the perturbations, etc. When it concerns an industrial product, configuration of the packaging chains can be decisive in choosing the acquisition zone. Not all of the zones are always easily visible in the chains.

2. A phase for detection and acquisition of at least one characteristic is executed in order to generate at least one digital signature. This characteristic can be acquired in several ways, such as the following for example:

a direct optical shot of the contours of the internal or external surfaces of the manufactured products;

an optical shot acquired, for example, by placing a target behind the flask and by retrieving the deformed signal through the manufactured product;

a sound emission, with retrieval of the returned signal;

laser systems that are used to measure the thickness of the walls proper to each manufactured product;

X-ray images; and/or
any other physical measurement connected with the characteristics of the manufactured product.

3. Processing of the raw “images” in order to extract from them at least one digital signature.

This processing can be achieved by different known and conventional methods for analysis and processing of the signal, of the optical, electronic or any other type.

All types of digital or analogue filters are usable.

For example and non exhaustively, these include:

Fourier transform,

Transform by so called wavelets.

The analysis and extraction of data must preferably be sufficiently reliable and or with sufficient redundancy so that the alteration of a part of the manufactured product, or of the acquisition zone, will result in generation of the digital signature.

4. The signatures are preferably stored in digital form, though this is not exclusive of others. Management of the base is then proper to the tracing solution.

Re-reading of the product is effected in the same way and its digital signature is compared with that of the base.

Monitoring of the product is effected in a conventional manner. The checking system proper to this present invention may be fixed, in which case the flasks will be brought to the site.

A portable version can allow reading of the products in situ however.

This present invention has many advantages in relation to previous techniques. Thus, the principle of using one or more macroscopic random or stochastic characteristics is very useful since we get over the principle that “Anything done by man can be undone or re-done by man” which is Achilles heel of most current solutions.

In addition, this present invention avoids or reduces the risk associated with destruction of the digital signature. In fact, alteration of part of the product does not prevent the generation of a unique signature that is sufficient for its identification in a reliable manner.

Another aspect of this present invention deals with the protection of information. The use of intrinsic characteristics by digital processing in order to obtain one or more digital signatures renders the information not directly accessible or translatable. In fact it is necessary to know the chosen characteristic and the processing used in order to generate the signature.

However, although in use it seems necessary to render it accessible, the information generated by this present invention can be connected to the product and/or to the packaging, either by repeating the digital signature generated by this present invention or by another signature that is then correlated at the database.

The acquisition system of this present invention will then be as close as possible to placement in the secondary pack, when it is itself traced, thus allowing correlation between the digital signature or signatures of the primary and secondary within the database.

FIG. 1, FIG. 2 and FIG. 4 show an example of digital signatures obtained from macroscopic characteristics of products used in the perfume industry. In this example, the images are taken directly and treated with different filters. This is at the start of stage 3, allowing a digital signature to be generated.

This present invention is particularly applicable to the case of flasks, in particular for perfume. The methods of manufacture provide these with internal shapes that are easy to use for the techniques of this present invention. The aesthetic research that guides the creation of these flasks conducts their shape toward an increasing complexity that is favourable to the method of this present invention.

It can concern the front of a manufactured product for example, or the bottom of a flask or a particular area on one of the faces.

1. A method for tracing a product, characterised by the use of at least one digital signature proper to the product, obtained from at least one intrinsic geometrical or physical macroscopic characteristic of said product in whole or in part, without the addition of a mark or of material.

2. A method for tracing a product according to claim 1, wherein said method includes a stage for reading a digital signature proper to the product, obtained beforehand from at least one intrinsic geometrical or physical macroscopic characteristic of said product in whole or in part, rendering account of its random, unique and stable structure.

3. A method for tracing a product according to claim 1, wherein trace reading cannot be prevented, and wherein the method includes a stage for the acquisition of a digital signature from at least one intrinsic geometrical or physical macroscopic characteristic of said product in whole or in part, in which any alteration, necessary to prevent reading, results in damaging the appearance of the product sufficiently to prevent its sale, or even destroys it.

4. A method according to claim 1, wherein the product is a flask, a bottle, a box, a tube or a pack, preferably a perfume flask or a primary cosmetics pack.

5. A method according to claim 1, wherein the macroscopic characteristic is chosen from amongst the thickness of the walls of the product, its external or internal shapes, and its resistivity.

6. A method according to claim 1, wherein the digital signature is obtained by optical, sound, laser or X-ray means.

7. A method according to claim 1, that includes the following stages:
a. determination of an acquisition zone for a digital signature on the product;
b. acquisition of a geometrical or physical characteristic of the product, at the level of said acquisition zone;
c. acquisition of a digital signature from the characteristic obtained in b);
d. storage of the digital signature, with a view to its later reading in the context of a tracing procedure.

8-10. (canceled)

11. An installation for the production of a manufactured product, wherein said installation includes a system for the acquisition of a digital signature from at least one macroscopic characteristic of each manufactured product, allowing its identification in a unique manner.

12. A method for the production of a manufactured product, wherein said method includes a stage for the acquisition of a digital signature from at least one macroscopic characteristic of the manufactured product, allowing its identification in a unique manner.

13. A method for identifying the origin of a manufactured product, wherein said method includes a stage for determining at least one digital signature proper to the product from at least one intrinsic geometrical or physical macroscopic characteristic of said product in whole or in part, and comparison of this signature with a pre-recorded signature, used to attest to the origin of the product.
